(19) United States
(12) Patent Application Publication
(10) Pub. No.: US 2012/0078720 A1
(43) Pub. Date: Mar. 29, 2012

(54) VIRTUAL DESKTOP SERVICE WITH TARGETED ADVERTISEMENT

(75) Inventors: Jonathan R. Pappas, San Francisco, CA (US); Frank C. Pesek, Emeryville, CA (US); Young G. Song, Palo Alto, CA (US); Richard Sah, San Mateo, CA (US)

(73) Assignee: STARTFORCE, INC., San Francisco, CA (US)

(21) Appl. No.: 12/892,259

(22) Filed: Sep. 28, 2010

(51) Int. Cl. G06Q 30/00; G06F 3/048

(52) U.S. Cl. 705/14.55; 715/810; 705/14.73; 705/14.66; 705/14.58

(57) ABSTRACT

Presenting advertisements in graphical user interfaces associated with virtual computers based on user profiles and information about user activities on the virtual computers. A computer device for instantiating the virtual computers analyses user profiles and the user activity information. Based on the analysis, the computer device selects advertisements for presentation to users. The computer device includes the selected advertisements in data objects for transmittal to user terminals of the users. The user terminals generate user interface elements for displaying the graphical user interfaces based on the received data objects. The users may take actions based on the advertisements presented in the graphical user interfaces. By presenting the advertisements, the service provider of computer virtual desktop service may collect monetary compensation from advertisers.

### CROSS REFERENCE TO RELATED APPLICATIONS

This application is related to U.S. patent application Ser. No. 12/881,079, filed on Sep. 13, 2010, and titled “Disposable Virtual Desktop for Transient Use by Multiple Users”; and U.S. patent application Ser. No. 12/887,398, filed on Sep. 21, 2010, and titled “On-Premise Deployment of Virtual Desktop Service Servers.”

### BACKGROUND OF THE INVENTION

1. Field of the Invention

This invention relates generally to desktop virtualization, and more specifically to presenting advertisements in graphical user interfaces associated with virtualized desktops.

2. Description of the Related Art

Desktop virtualization involves storing a logical representation of a personal desktop computer (hereinafter referred to as “desktop”) on a remote server and implementing the functionality of the desktop on the remote server. In many cases, the remote server implements multiple versions of virtual desktops, where each version of the virtual desktop is individualized for a single user who accesses the remote server via a network. Although specific tasks assigned to the remote server and the user terminals differ based on implementations, the remote server often performs most of the heavy processing tasks while the user terminals often performs relatively light processing tasks such as generating graphical user interfaces and tracking user input activities. By leveraging the resources of the remote server, even a thin client device with limited capabilities can perform operations that require high-performance computing devices.

The desktop virtualization has, among others, the following advantages: First, updating and maintaining operations (e.g., installation of updated software) are less time-consuming because these operations can be performed centrally at the remote server. Second, the recovery operation associated with failed desktops can be performed efficiently because a flawed virtual desktop can be deleted and replaced with a new version of virtual desktop in a relatively small amount of time. Third, the operation of the desktop can be monitored and managed centrally, reducing security risks. The virtual desktop can be shutdown or restarted from a central location in case of a security event. Fourth, the overall cost for purchasing or renting devices can be lowered because low performance user terminals can be deployed even for applications that require high-performance computing devices.

Generally, conventional virtual desktop infrastructure (VDI) creates, stores and loads full images of software components (including an operating system) for each virtualized desktop. To instantiate and execute multiple virtual desktops, the conventional schemes often employ a hypervisor to share hardware resources of the remote server across the multiple instances of virtual desktops. However, managing multiple images of desktops and operating the hypervisor consume a large amount of storage and processing resources at the remote server. Further, each image of the software components may include duplicative components that occupy memory space within the remote server. Hence, conventional desktop virtualization schemes have limited scalability and suffer from inefficient use of resources.

Moreover, conventional desktop virtualization schemes adopt proprietary communication protocols to transmit data between the remote server and the user terminals. These communication protocols typically transmit low-level pixel data to the user terminal to display a graphical user interface on the screen of the user terminal. Transmission of such low-level pixel data often requires significant communication bandwidth and also renders the processes associated with the desktop virtualization inefficient.

Such conventional desktop virtualization schemes require expensive hardware and/or software resources to host each instance of virtual desktop. Installing and maintaining the hardware and software resources require extensive capital expenditure on the part of virtual desktop service provider. Hence, conventional virtual desktops are generally created and provided only to paid users or subscribers. Further, the conventional desktop virtualization schemes grant the users extensive control over the virtual desktops. Consequently, the virtual desktop service provider has limited control over the virtual desktops. The lack of service provider's control over the virtual desktops make it challenging for the virtual desktop service provider to generate revenue for operating a virtual desktop service without relying on subscription fees or installation fee from subscribers or users.

### SUMMARY OF THE INVENTION

Embodiments relate to presenting one or more advertisements on a user interface on a user terminal for accessing a computer virtualized in a computing device. The computing device instantiates a plurality of virtual computers that can be access by a plurality of user terminals. The user terminals communicate with the computing device over a network. The computing device converts the one or more advertisements to data objects for transmission to the user terminals. The computing device sends data objects corresponding to the advertisements and other data objects related to user interface elements to the user terminals over the network.

In one embodiment, the advertisements for presentation are selected based on user profiles or information related to user activity associated with the virtualized computer. The user profile may include at least one of user's contact information, the user's demographic information, the user's geographic location, the user's preferred language, and the user's field of interest.

In one embodiment, the computing device also receives event information representing selection of an advertisement at the user terminal. In response, the computing device generates a data object including a media item associated with the advertisement selected at the user terminal and sends data object to the user terminal over the network. The media items may include an image, a video clip, a webpage or an animation.

In one embodiment, the one or more advertisements are encoded and packaged into one or more JSON objects (JavaScript Object Notation). The JSON objects may be sent to the user terminals via HTTP (Hypertext Transfer Protocol) or its variant protocol.

In one embodiment, the advertisements may be presented on the user interface in various modes. The modes may include a first mode where at least one advertisement is displayed at a stationary location in the user interface; a second mode where at least one advertisement blinks, changes shape, change size or location in the user interface; a third mode where at least one advertisement appears as a background image; a fourth mode where at least one advertisement appears in a login screen for accessing the virtualized computer; a fifth mode where at least one advertisement appears in a screen saver; a sixth mode where at least one advertisement appears in a label of an application window; a seventh mode where at least one advertisement is overlaid on a graphical user interface element representing a file or folder; an eighth mode where at least one advertisement appears in a graphical user element indicating loading of an application; and a ninth mode where at least one advertisement appears in a dialog box.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. (Figure) 1 is a diagram illustrating the architecture of a desktop virtualization system, according to one embodiment.

FIG. 2 is a schematic block diagram of a remote server cluster, according to one embodiment.

FIG. 3 is a block diagram of a service server, according to one embodiment.

FIG. 4 is a block diagram illustrating components of a virtual desktop application, according to one embodiment.

FIG. 5 is a block diagram illustrating components of a user terminal, according to one embodiment.

FIG. 6 is a flowchart illustrating a method of selecting and presenting advertisements in a graphical user interface associated with a virtual desktop, according to one embodiment.

FIG. 7A through 7G are graphical user interfaces including advertisements, according to embodiments.

### DETAILED DESCRIPTION OF THE EMBODIMENTS

Reference in the specification to “one embodiment,” “an embodiment” or “the embodiment’ means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, a personal digital assistant (PDA), a cellular telephone or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, flash memory or drives, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Embodiments relate to presenting advertisements in graphical user interfaces associated with virtual computers. A computer device for instantiating the virtual computers analyses user profiles, user's current geographic location and the user activity information. Based on the analysis, the computer device selects advertisements for presentation to users based on user profiles and information about user activities on the virtual computers. The computer device includes the selected advertisements in data objects for transmittal to user terminals of the users. The user terminals generate user interface elements for displaying the graphical user interfaces based on the received data objects. The users may take actions based on the advertisements presented in the graphical user interfaces.

A user profile described herein refers to information about a user associated with a virtual computer. The user profile may include, for example, user's contact information (e.g., email address or physical address), the user's demographic information (e.g., age, gender and ethnicity), user's preferred language, and user's field of interest. The user profile may also include information about the user's location.

A user interface element described herein refers to any information for defining a graphical user interface. The user interface element may include, for example, windows, icons, background images and color themes.

### Architecture of Desktop Virtualization System

FIG. (Figure) 1 is a diagram illustrating the architecture of a desktop virtualization system 100, according to one embodiment. The desktop virtualization system 100 may include, among other components, a network 110, user terminals 130, remote server clusters 140, one or more application servers 150, an authentication server 160, a file storage server 170, and a database server 180. The desktop virtualization system 100 may include components not illustrated in FIG. 1. Further, two or more components illustrated in FIG. 1 may be combined into a single component. For example, in a simplified version of the architecture, the application servers 150, the authentication server 160, the file storage server 170, and the database server 180 may be combined into a single server.

The network 110 allows communication of data between various components of the desktop virtualization server 160. The network 100 may include multiple processing systems and in one embodiment is a network controller. The network of processing systems may comprise a local area network (LAN), a wide area network (WAN) (e.g., the Internet), and/or any other interconnected data paths across which multiple devices may communicate. The network 100 may use standard network protocols such as TCP/IP, HTTP, HTTPS, and SMTP as well as customized network protocols.

The user terminals 130 are computing devices that allow users to access virtual desktops executed and running on the remote server clusters 140. Each of the user terminals 130 includes components for generating and displaying a graphical user interface elements to interact with the user and a networking component to exchange data with other components of the desktop virtualization system 100, as described below in detail with reference to FIG. 5. The user terminals 130 may include, but are not limited to, desktop computers, laptop computers, tablet computers, personal digital assistants (PDAs), cell phones, smartphones, game consoles, set-top boxes, and televisions or other appliances with networking capabilities.

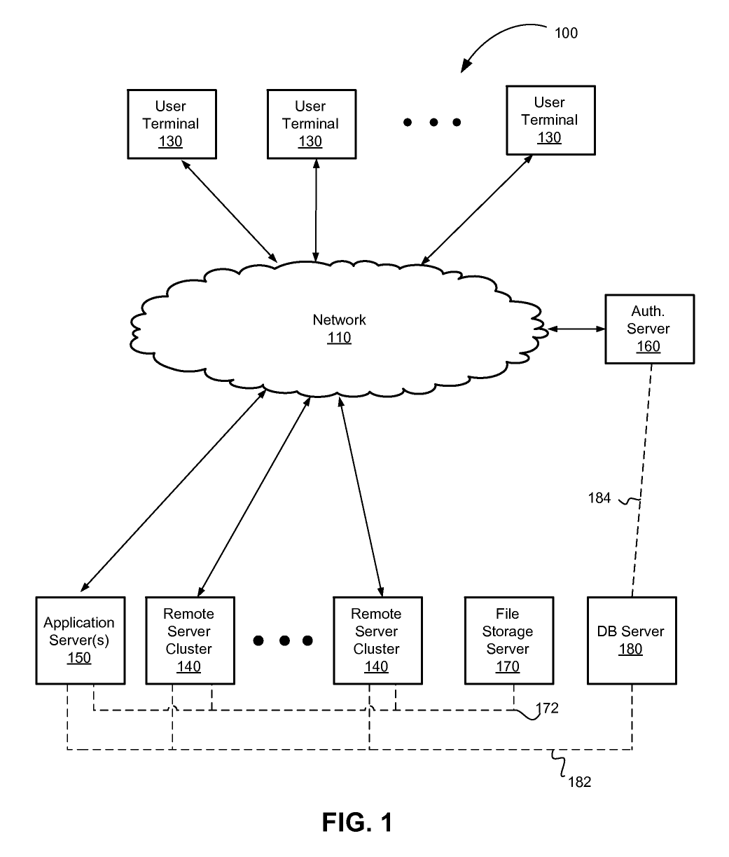

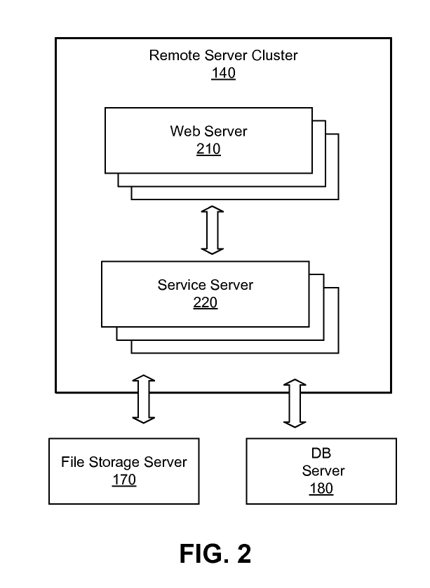

The remote server clusters 140 include one or more servers for providing virtual desktop services to the users. Although multiple remote server clusters 140 are illustrated in FIG. 1, only a single server or a single server cluster may be provided in the desktop virtualization system 100. The remote server cluster 140 may be located in distinct geographic locations or jurisdictions remote from the users. The remote server clusters 140 may include, among other components, web servers and service servers, as described below in detail with reference to FIG. 2. One of many functions of the remote server clusters 140 is to perform operations associated with managing, processing and storing the virtual desktops.

The application servers 150 execute, for example, the follow application programs: (i) the application programs that require a large amount of resources, (ii) the application programs that operate on a legacy software or hardware that is incompatible with those of servers in remote server clusters, or (iii) the application programs that are managed at a separate server for other business or technical reasons. Some application programs consume a significant amount of resources and may interfere with other operations of servers in the remote server clusters 140. Such application programs may include Quickview and Java Mail Client (JMC), both available from Startforce, Inc. of San Francisco, Calif. Quickview application generates image versions of documents in various formats to allow the users to conveniently view these documents without launching applications associated with these documents. The conversion of documents into the images involves a considerable amount of processing. JMC is a program that integrates with email servers to receive, compose, reply, forward and manage emails. JMC program may take up a considerable amount of communication bandwidth. Hence, it is advantageous to execute such application programs on a separate application server 150. Some applications from certain application programs operate on a server with certain software components and hardware configuration. For such application, it is advantageous to deploy a separate application for running the application programs. For example, to execute WINDOWS OFFICE suite (available from Microsoft, Inc. of Redmond, Wash.), WINDOWS® Terminal Services (also available from Microsoft, Inc. of Redmond, Wash.) must be installed on the server. Hence, it is advantageous to load and operate such application programs on a separate application server 150 adapted for the application programs. Finally, certain application programs require a separate license to operate on difference servers. In such cases, it is advantageous to operate these application programs on a dedicated server to reduce the license fees.

The authentication server 160 performs operations associated with user account management and/or load balancing across the remote server clusters 140. The user account management operations may include, for example: creating, updating or deleting user profiles stored in its internal memory or the database server 180; authenticating the users based on accessed user profiles; and approving access of the users to certain application programs. The authentication server 160 may also perform load balancing by determining the load conditions of individual or collective load of servers in the remote server clusters 140, and distribute user requests to multiple remote server clusters 140 depending on the load conditions. The authentication server 160 and the database server 180 may communicate data associated with the user account via the network 110 or a physical or logical channel 184 dedicated to communication between the authentication server 160 and the database server 180.

The file storage server 170 stores various files associated with the desktop virtualization. The stored files may include any files uploaded or generated by the users and temporary files generated by the desktop virtualization system 100 during operations associated with virtualization sessions. The remote server clusters 140 and the application servers 150 may access the files stored in the file storage server 170 to perform various operations. In one embodiment, the file storage server 170 is combined with the database server 180.

The files may be communicated to and from the file storage server 170 via the network 110 or a physical or logical channel 172 dedicated to communicating the files. Although FIG. 1 illustrates only a single file storage server 170, two or more file storage servers 170 may be deployed at the same or different geographical locations.

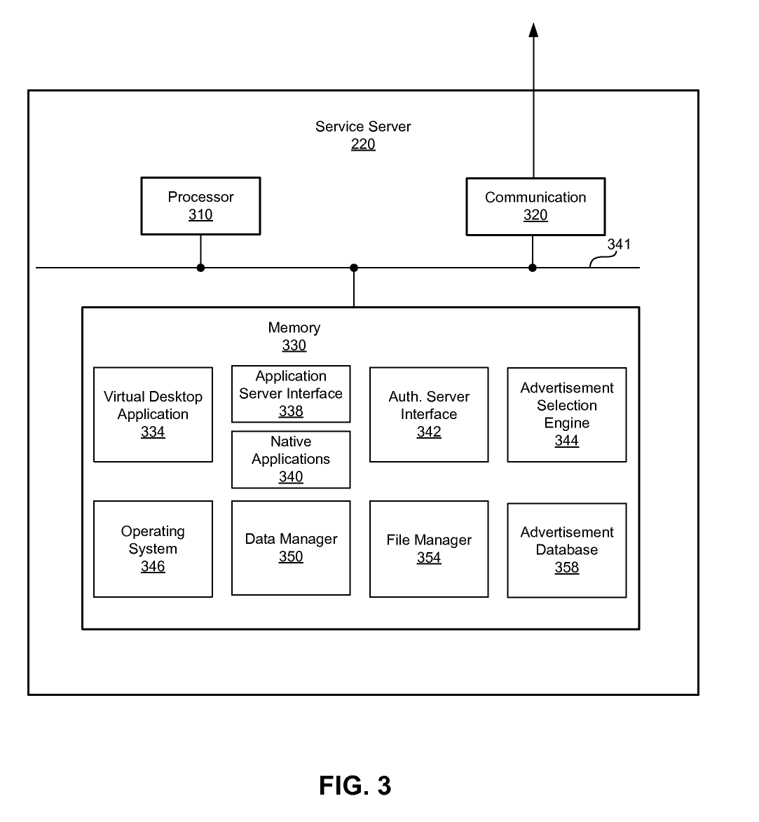

The database server 180 may store data entries associated with, for example, the user profiles, desktop profiles and metadata of the files. The user profiles include information about the user, as described below in detail with reference to FIG. 3. The desktop profile includes information about properties and characteristics of a virtualized desktop for a user, as described below in detail in a subsequent section titled “Desktop Profile.” The metadata in the database server 180 represent information about files stored in the file storage server 170, as described below in detail with reference to FIG. 3. In one embodiment, the database server 180 is embodied as a server running MySQL available from Sun Microsystems of Santa Clara, Calif.

The data to or from the database server 180 may be communicated via the network 110 or a physical or logical channel 182 dedicated to communicating the user profiles or file metadata. Although FIG. 1 illustrates only one database server 180, two or more database servers 180 may be deployed at the same or different geographical locations.

Although the architecture of the virtual desktop system 110 in FIG. 1 distributes various functionalities across different servers in cloud computing environment, these functionalities may be provided by one or more servers co-located in the same premise. Some companies may prefer to have exclusive access to the servers for security or performance reasons. In such cases, a small number of servers located at the same premise may embody the functionalities of the authentication server 160, the remote server clusters 140, the file storage server 170, the application servers 150, and the database server 180. Alternatively, a hybrid model may be employed to assign part of functionalities to one or more servers privately controlled by the companies while assigning other functionalities to public servers.

### Architecture and Functions of Remote Server Cluster

FIG. 2 is a schematic block diagram of the remote server cluster 140, according to one embodiment. The remote server cluster 140 may include, among other components, one or more web servers 210 and one or more service servers 220. The web server 210 communicates with the service server 220 to transmit data for virtualized desktop to the user terminals 130 over the network 110, and passes information about user input activities at the user terminals 130 to the service server 220. Although FIG. 2 illustrates the web servers 210 and the service servers 220 as being embodied on separate servers, the web servers 210 and the service servers 220 may also be embodied in a single physical server. Alternatively, the web server 210 and the service server 220 may be located remotely from each other and communicate over the network 110 or other communication channels.

The web server 210 communicates data objects generated at the service server 220 to the user terminals 130 over the network 110. Various protocols may be used to communication data between the user terminals 130 and the web server 210. In one embodiment, the web server 210 uses web-based protocols such as HTTP (Hypertext Transfer Protocol) or its variant (e.g., HTTPS) to communicate with the user terminals 130. Compared to transmitting the pixel-level data over protocols such as RDP (Remote Desktop Protocol) or ICA (Independent Computing Architecture), using the web-based protocols has the following advantages: (i) the web-based protocols enable the web server 210 to communicate data associated with virtual desktops in a bandwidth-efficient manner, (ii) the web-based protocols eliminate or reduce software components that needs to be installed on the user terminals 130, (iii) the web-based protocols enable virtual desktop operations to be performed in a manner that is agnostic to operating systems, (iv) the web-based protocols facilitates development of applications compatible with the virtualization environment, (v) technology related to the web-based protocols are actively being enhanced, and hence, the web-based protocols can leverage various developments in related technology, and (vi) web-based protocols allow graphical user interfaces to be rendered and presented on the user terminals 130 in an efficient manner.

The web server 210 may include, among other components, a processor, a computer-readable storage medium (e.g., RAM (Random Access Memory)) and a communication interface (e.g., network card). The computer-readable storage medium stores computer instructions associated with Web server applications such as IBM WebSphere and Apache Web server that are executed by the processor. The web server 210 may also run middle layer applications to interface with the service server 220 and the user terminals 130.

The service server 220 generates data objects related to virtual desktops for transmission to the user terminals 130 via the web server 210. The service server 220 also received information about user input activities (e.g., clicks of mouse or typing of a keyboard) from the user terminals 130 via the web server 210. Based upon the user input activities, the service server 220 performs various operations associated with the virtual desktop such as moving the location of icons, opening of files, and launching of an application. To perform its operation, the service server 220 may communicate with the application servers 150, the file storage server 170 and the database server 180.

FIG. 3 is a block diagram illustrating the service server 220, according to one embodiment. The service server 220 may include, among other components, a processor 310, a communication module 320, a memory 330 and a bus 340 connecting these components. The processor 310 reads instructions and data from the memory 330 and performs operations. The communication module 320 is hardware, software, firmware or any combinations thereof for communicating with other components of the desktop virtualization system 100. The service server 220 illustrated in FIG. 3 is merely illustrative. Various other hardware, software or firmware may be provided on the service server 220 to perform additional functions or enhance performance.

The memory 330 is a computer-readable storage medium that stores instruction modules such as a virtual desktop application 334, an application server interface 338, one or more native applications 340, an authentication server interface 342, an advertisement selection engine 344, an operating system 346, a data manager 350, a file manager 354 and an advertisement database 358. Two or more of these instruction modules may be combined into a single instruction module. Alternatively, one or more of these instructions modules may be divided into smaller instruction modules. Further, some of the instruction modules in FIG. 3 may be stored and executed on other components of the desktop virtualization system 100.

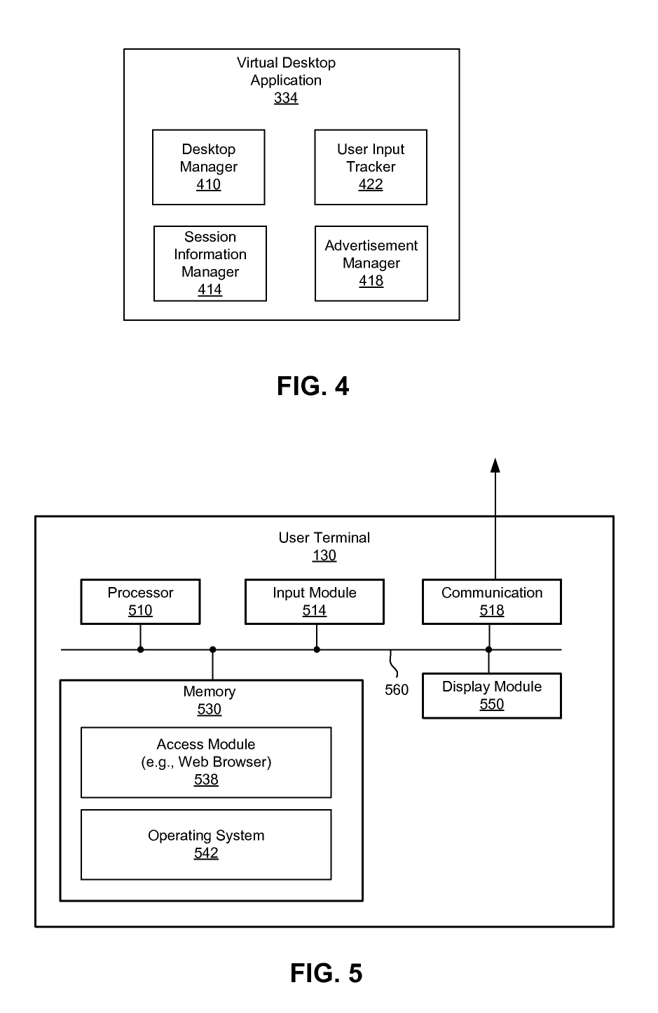

As described below in detail with reference to FIG. 4, the virtual desktop application 334 generates and sends data objects associated with virtual desktops to present graphical representations of the virtual desktops on the user terminals 130 as well as track and detect user input activities on the user terminals 130.

The application server interface 338 operates in conjunction with the virtual desktop application 334 to interface with the application servers 150. If the virtual desktop application 334 determines that a task requires assistance of the applications servers 150, the virtual desktop application 334 issues a command instructing the application server interface 338 to collect and send information for initiating operations on the application servers 150. The application server interface 338 may also receive the result of the operations from the application server 150 and forward the result to the virtual desktop application 334. The virtual desktop application 334 then generates data objects based on the result and sends the data objects to the user terminals 130 for presentation to the users.

Alternatively, the application server interface 338 may hand over the control of user interaction to the application server 150 when needed so that the application server 150 communicates directly with the user terminals 130. After the operations on the application server 150 is terminated, the application server interface 338 indicates to the virtual desktop application 334 that the virtual desktop application 334 should resume communication with the user terminals 130. In response, the virtual desktop application 334 resumes the control of user interaction.

The process of sending the requests to the application servers 150 and receiving the requests via the application server interface 338 may be performed in a manner that is transparent to the users. From the perspective of the users, operations on the virtual desktops appear as being operated on a single server. In one embodiment, the application server interface 338 communicates with the application servers 150 using, for example, HTTP, HTTPS, RDP (Remote Desktop Protocol) and ICA (Independent Computing Architecture).

The native applications 340 are applications designed to operate and launch in the virtual desktop environment. The native applications 340 may include, for example, text editors, media players, messengers, and file upload/download programs. These native applications 340 typically do not require a large amount of resources, and can be launched and executed on the virtual desktop application 334 without significantly affecting other operations associated with the virtual desktop. In one embodiment, the native applications interface with Startforce API (Application Programming Interface) available from Startforce, Inc. of San Francisco, Calif. to interact with the users.

The authentication server interface 342 communicates with the authentication server 160 to receive information about an authenticated user to grant access to the virtual desktop services. In one embodiment, the information about the authenticated user is a pointer to a user profile in the database server 180.

In one embodiment, the authentication server interface 342 tracks the load condition at the service server 220. The load condition may indicate, for example, the average percentage of processing capacity or memory capacity being used for a predetermined amount of time. The authentication server interface 342 sends information about the load conditions to the authentication server 160. Based on the load conditions, the authentication server 160 may determine which service server 220 to handle subsequently received user requests.

The advertisement selection engine 344 selects advertisements for presentation to the user. In one embodiment, the advertisement selection engine 344 analyzes the user profiles and other information associated with the user's operation on the virtual desktop to determine the advertisements to be selected for presentation. The advertisements may be selected with the goal of providing advertisements that are of interest or help to the users or increasing advertisement revenue. After the advertisement selection engine 344 selects the advertisements, the identifications of the advertisements or the advertisements themselves are sent to the virtual desktop application 334 to generate advertisement objects. The operation of the advertisement selection engine 344 is described below in detail in a section entitled “Advertisement Selection and Presentation.”

The operating system 346 manages resources of the service server. The operating system 346 may include, for example, Windows Server, Linux, OSX, Solaris 10, Netware, IRIX, and AIX. In one embodiment, the virtual desktop application 334 does not use a hypervisor to provide the virtual desktop services. Instead, the virtual desktop application 334 uses virtual desktop profiles and web-based protocols to embody virtual desktops, as described below in detail with reference to FIG. 4. By obviating a hypervisor to manage multiple images of operating systems, the performance and scalability of the virtual desktop deployment are increased.

The data manager 350 communicates with the database server 180 to access database entries associated with, among others, the user profiles, the desktop profiles and the file metadata. The user profile may include, for example, the following fields: User ID, user password, user's nickname, user's email address, user's role (e.g., administrator or non-administrator), identification of the organization associated with the user, user's resident address, maximum resources (e.g., communication bandwidth or maximum data storage in the database server 180), previous log-in time or log-out times, whether the user is a paying or free subscriber, user's gender, user's age, and user's ID on social networking services (e.g., Twitter or Facebook). The user profile may be associated with application permission information indicating applications that the user is permitted to access. During the logging-in process, the authentication server interface 342 sends the information received from the authentication server 160 to virtual desktop application 334 to instantiate the virtual desktop for the user.

The file metadata includes information about a file associated with a user, and may include some or all of the following fields: the name of the file; the user associated with the file; the size of the file; the extension of the file; whether the file indicates a directory or not; whether the file is shared across all or a subset of users; when the file was created, accessed or modified; whether the file counts towards a storage quota assigned to the user; whether the file is encrypted; and a path on the file storage server 170 where the file is stored.

Many advantages of managing the file metadata on the database server 180 separate from the file storage server 170 are as follows: (i) various operations associated with files that do not require actual access to the files can be performed more efficiently and promptly, (ii) the overall size of the data in the database server 180 can be reduced to provide faster overall performance and facilitate various management operations, (iii) statistical analysis for various purposes can be performed more efficiently, and (iv) reduces risks associated with corruption in data entries of the database server 180.

Alternatively, the files can be stored in the database server 180 as blobs instead of being storing in a separate file storage server 170.

The advertisement database 358 stores information associated with advertisements for presentation to the user. The advertisement database 358 is accessed by the advertisement selection engine 344 to select the advertisements for presentation to the users. The advertisement database 358 may include, among others, (i) advertisements files (e.g., images, video clips, and code), (ii) information related to fees generated by presenting the advertisements (e.g., cost per click (PPC) and cost per impression (CPI)), and (iii) statistics associated with the advertisements (e.g., clickthrough rate (CTR) and users' like/dislike ratio).

### Desktop Profile

Virtualizing a desktop by managing an image of a user's entire software (including the operating system) installed on a desktop may be resource intensive. Hence, instead of creating and managing separate software images for users, embodiments store information about a user's virtualized desktop in a compact desktop profile and user files. The graphical representation of the virtual desktop is generated on the user terminal 130 based on the desktop profiles and the user files. In this way, embodiments achieve virtualization of desktops for multiple users without maintaining the software image of a desktop computer and also without running a resource-intensive hypervisor on the service server 220. As a result, a virtualized desktop account can be set up for a user with only incremental increase in storage requirement.

For example, the additional memory required for an additional user may be as low as 368 Kbytes whereas additional storage space of as much as 5 Gigabytes is required to establish a virtual desktop account in other conventional desktop virtualization systems.

The desktop profiles are stored in the database server 180 and retrieved by the data manager 350. Based on the retrieved desktop profiles, the virtual desktop application 334 instantiates a virtual desktop after receiving a user's request. A desktop profile includes, among other information, the following: (i) information associated with graphical user elements (e.g., icons) to be displayed at the user terminal 130 of the user, such as the identification of the graphical user elements (e.g., an icon representing a document) and their coordinates on a screen or window of the user terminal 130, (ii) user preferences associated with the presented desktop (e.g., background color or image of the virtual desktop screen), (iii) information about association of file types with application programs, (iv) the user's language (e.g., English, Chinese), and (v) application permissions for controlling availability of application to the user.

Example information about the association of file types for a BMP image file, as stored in the desktop profile, is listed in following Table 1.

TABLE 1

| Field | Data type | Examples |
|---|---|---|
| filetype_extension | Character | bmp |
| filetype_description | Character | BMP Image |
| filetype_icon | Character | file_picture.gif |
| Application | Character | com_startforce_app_PictureViewer |

Table 1 indicates that the virtual desktop application 334 associates any files with extension of “.bmp” with a BMP image (filetype_description). For files with “.bmp” extension, the virtual desktop application 334 represents this file on a virtual desktop using an icon named “file_picture.gif” Further, when the user attempts to open files with “.bmp” extension (e.g., by double clicking the icon on the user terminal 130), the virtual desktop application 334 launches application “com_startforce_app_PictureViewer” and loads the double-clicked file onto the launched application. Separate tables may be generated and managed for each type of files.

In one embodiment, when a user first logs-on to the remote server cluster 140, the user is presented with a graphical user interface screen similar to a desktop window on an operating system such as WINDOWS series operating system (available from Microsoft Corporation of Redmond, Wash.) and OS X operating system (available from Apple Inc. of Cupertino, Calif.) based on the desktop profile. If the user changes the locations of icons, generates or uploads files or changes default applications for launching certain types of files, the desktop profile of the user is updated accordingly and stored in the database server 180 after the user logs off. Hence, when the same user later logs-on, the user is presented with the same graphical user interface screen that was presented to the user before the user logged-off.

### Virtual Desktop Presentation and Interfacing

FIG. 4 is a block diagram illustrating the virtual desktop application 334, according to one embodiment. The virtual desktop application 334 may include, among other components, a desktop manager 410, a user input tracker 422, a session information manager 414 and an advertisement manager 418. The virtual desktop application 334 may also include other components for providing additional services to the user.

The desktop manager 410 performs, among other functions, the function of generating data objects and sending the data objects to the user terminal 130 for presentation to the user. When a HTTP request is received from the user terminal 130 via the web server 210, the desktop manager 410 accesses a library to assemble data objects and encode the data objects for transmittal to the user terminal 130. The data objects for transmittal include, for example, window objects, menu objects, theme objects and user session objects, which are processed by the user terminal 130 to render windows, menu items, textual data and other desktop images. In one embodiment, these objects are encoded and packaged as JSON (JavaScript Object Notation) objects. The desktop manager 410 then sends the JSON objects via the web server 210 as a HTTP response.

The following is an example pseudo-code of JSON objects:

{result:[
{“isdir”:true,“ts”:1280241204000,“isencrypted”:0,“pid”:
“m”,“date”:“Tuesday, July 27, 2010
2:33PM”,“size”:0,“id”:“m275328”,“isshared”:false,“owner
name”:“userXYZ”,“name”:“MyMovies”,“owner”:2892,“path”:“
”},
{“isdir”:true,“ts”:1280241203000,“isencrypted”:0,“pid”:
“m”,“date”:“Tuesday, July 27, 2010
2:33PM”,“size”:0,“id”:“m275299”,“isshared”:false,“owner
name”:“userXYZ”,“name”:“Desktop”,“owner”:2892,“path”:“”
}
]}

The above pseudo-code is included in a HTTP response from the virtual desktop application 334 generated in response to receiving a HTTP request from the user to open a native application for viewing and navigating through folders and files associated with the virtual desktop. The above pseudo-code includes two JSON objects, one indicating “MyMovies” folder, and another indicating “Desktop” folder. The entire JSON object is delimited by the curly braces (“{”, “}”), and each of the JSON objects is formatted in a name-value pair delimited by curly braces (“{”, “}”). “isdir” field may take a true or false value and indicates whether the data object is associated with a folder or file. “ts” field relates to time stamp indicating the time that the JSON objects were generated, “isencrypted” field takes a true or false value and indicates whether the folder or file is encrypted or not. “pid” field represents a parent entity (e.g., folder) of the JSON object to implement hierarchy of data objects. “date” field indicates the date that the JSON object was originally created. “isshared” field takes a true or false value and indicates whether the folder is shared with other users. “owner name” indicates the user associated with the file (here, the use is “userXYZ”). “name” field indicates the name of the JSON object. “owner” field is followed by a unique number identifying the user. Finally, “path” field indicates the logical path of the file or folder in the virtual desktop (here, both folders are located at root).

The user input tracker 422 operates to receive event information from the user terminal 130 such as clicking of mouse buttons on an icon and typing on a keyboard. The event information may be encoded into JSON objects and then packaged into a HTTP request at the user terminal 130.

When the HTTP request from the user terminal 130 invokes operations on the application server 150, the desktop manager 410 sends a JSON object to the user terminal 130 to reserve resources on the user terminal 130 (e.g., an area on the screen of the user terminal 130) for interacting with the application server 150. The application server interface 338 (see FIG. 3) sends data necessary for performing the requested operation to the application server 150. The application server 150 then takes over the processing for the reserved area on the screen, and interacts with the user terminal 130 directly to send information and receive user input. The application server 150 may then access the file storage server 170 and the database server 180 to create, load, store, modify or delete files. If the HTTP request involves loading of a file onto the application server 150, the application server interface 338 retrieves the metadata of the file and sends the metadata to the application server 150. The applications server 150 may then load the file corresponding to the metadata for operation.

The session information manager 414 manages a virtual desktop session with a user by creating and updating session information for each session. The session information is stored in the file storage server 170 and may be accessed to restart a virtual desktop session. The session information may include, for example, the following: (i) IP address of the user terminal 130, (ii) information about programs being used, (iii) the user profile, (iv) web browser of the user terminal 130, (v) currently connected application server 150 or servers in remote server cluster 140, (vi) authentication token and (vii) statistical information such as login time and session length. If a service server 220 handling a user's request becomes inoperable, the session information may be retrieved by another service server 220 to resume the session with the user.

The advertisement manager 418 performs handling of advertisements, as described below in detail in a section entitled “Selection and Presentation of Advertisements.”

FIG. 5 is a block diagram of the user terminal 130, according to one embodiment. The user terminal 130 may include, among other components, a processor 510, an input module 514, a communication module 518, a memory 530, a display module 550, and a bus connecting these components. The user terminal 130 may include components such as a speaker not illustrated in FIG. 5. The processor 510 executes computer instructions stored in the memory 530 to perform various operations. The input module 514 is hardware, software, firmware or a combination thereof for receiving user input. The input module 514 may include, for example, one or more of mouse, keyboard, keypad, touchscreen and remote controller. The communication module 518 is hardware, software, firmware or a combination thereof for communicating with other components of the desktop virtualization system 100 via the network 110. The display module 550 is hardware, software, firmware or a combination thereof for displaying graphical user interface elements. The display module 550 may include, for example, a graphics processing unit, a display driver and a display screen.

The memory 530 stores software components for operating the user terminal 130. The software components in the memory 530 may include, among other components, an operating system 542 for managing and allocating resources of the user terminal 130 to various operations, and an access module 538 for accessing the virtual desktop instantiated on the service server 220. The memory 530 may store various other software components that are omitted herein for the sake of brevity.

The access module 538 may be embodied as any software for navigating and accessing web-based information from a web server over the network 110. In one embodiment, the access module 538 is embodied as a web browser capable of sending HTTP requests to web servers and receiving HTTP responses from the web servers. Example web browsers include Internet Explorer (IE) (available from Microsoft of Redmond, Wash.), Safari (available from Apple Inc. of Cupertino, Calif.), Mozilla Firefox (available from Mozilla Corporation of Mountain View, Calif.) and Chrome (available from Google Inc. of Mountain View, Calif.). After a user requests a virtual desktop session, the HTTP request is sent to the authentication server 160. The user provides user ID and password (or other authentication information) that is sent to the authentication server 160. If the user is successfully authenticated, then the authentication server 160 forwards the HTTP request to the remote server cluster 140.

The access module 538 renders the graphical representation of the virtual desktop by interpreting, for example, a combination of HTML, CSS, JavaScript, images and other related web technology components. In one embodiment, the access module 538 includes a Javascript/Ajax library for handling JSON objects. In response to the HTTP request, the access module 538 receives JSON objects from the remote server cluster 140. The access module 538 parses the received JSON objects, extracts data from the JSON objects, and renders a graphical user interface screen based on the extracted data. Most web browsers are capable of operating with Javascript/Ajax library, and hence, these web browsers can function as the access module 538 without installation of additional software components or with the installation of a small-sized library. Further, similar operations associated with virtualization can be expected from different web browsers because Javascript/Ajax library is accessed and used consistently throughout different web browsers. In one embodiment, Javascript/Ajax library is Startforce Javascript Application Framework available from Startforce, Inc. of San Francisco, Calif.

After an initial virtual desktop screen is presented on the screen of the user terminal 130, the user may perform operations such as launching an application or opening a file. In response to receiving user input for such actions at the input module 514, the access module 538 creates JSON objects based on the Javascript/Ajax library, and sends the created JSON objects to the remote server cluster 140 in a HTTP request. The remote server cluster 140 then performs operations based on the received JSON objects and returns another set of JSON objects for generating an updated graphical user interface screen on the user terminal 130. The access module 538 and the remote server cluster 140 exchange the JSON objects in the form of HTTP requests and HTTP responses to perform operations associated with the virtual desktop.

Communicating high-level JSON objects instead of low-level pixel data accompanies, among others, the following advantages: (i) the desktop virtualization system 100 can significantly reduce the bandwidth needed for performing virtual desktop operations, (ii) sending advertisements for presentation on the user terminal 130 can be simplified, and (iii) the virtual desktop operations may be performed using various web browsers with minimal or no additional software installation.

### Selection and Presentation of Advertisements

Conventional virtual desktop infrastructure (VDI) creates, stores and loads full images of software components (including an operating system) for each virtualized desktop. When a user has launched a conventional VDI desktop the activities performed are essentially autonomous from the server. In such conventional VDI, software components for dynamic placement of advertisements on the user's graphical user interface needs to be implemented at a layer on top of a hypervisor. Such a structure is vulnerable to user's attempt to deactivate or circumvent the advertisement software components. For example, the user may simply remove the software components associated with the advertisements from the virtualized desktop using tools installed and running on the virtual desktops to avoid watching advertisements. Although an administrator or service provider may reinstall the advertisement software components after the user's removal, such monitoring and administration is time-consuming and not scalable to a large number of users. Hence, any business model that attempts to rely on advertisement revenue in conventional VDI is unlikely to be successful.

In contrast, embodiments described herein obviate hypervisors and instead adopts desktop profiles to implement virtual desktop service. In addition to reducing the resources needed for virtualization, embodiments described herein provide environment amenable to a business model based on advertisement revenue for at least the following reasons. First, the virtual desktop service provider has a greater control over the manner and substance of data to be presented on the user terminal 130. Hence, the virtual desktop service based on the desktop profiles is less vulnerable to user's schemes to avoid viewing the advertisements. Second, the incremental cost for providing an additional virtual desk is very low compared to the hypervisor-based VDI. Hence, revenue generated from advertisements may be sufficient to accommodate additional users. Third, the service server 220 stores information that facilitates targeted advertisements to the users, as described below in detail. Fourth, the service server 220 has the ability to monitor all activity performed on the user terminal 130 providing a very granular control over the types of advertisements to be presented. Hence, the advertisers are likely to pay higher advertisement fees for advertisements presented on the virtual desktop.

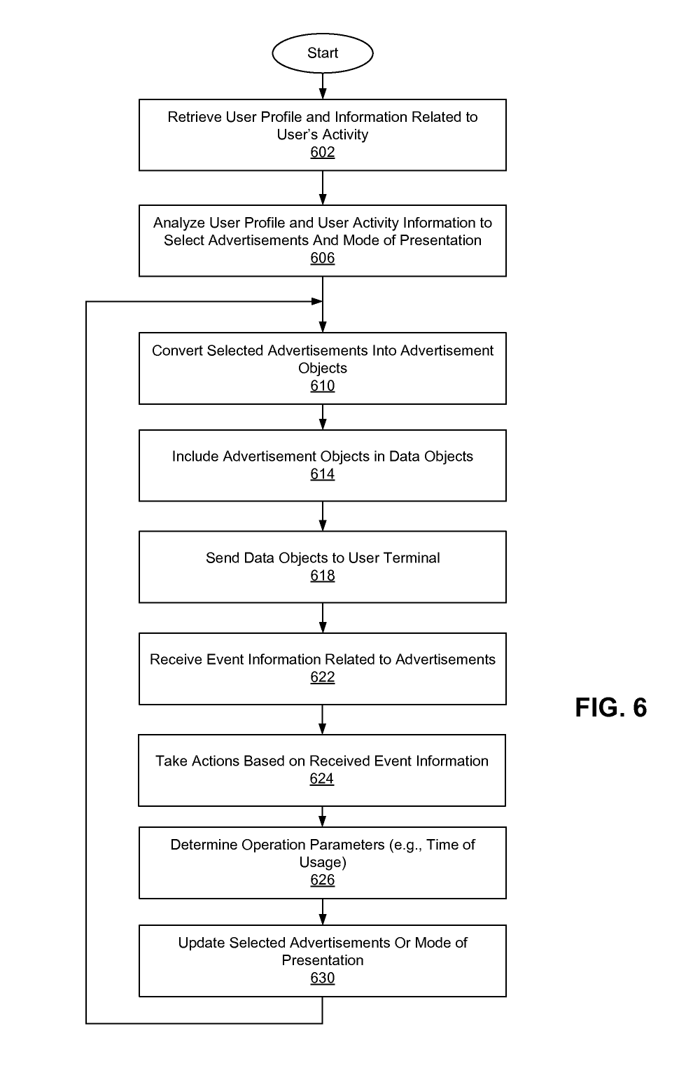

FIG. 6 is a flowchart illustrating a method of selecting and presenting advertisements in a graphical user interface associated with a virtual desktop, according to one embodiment. The advertisement selection engine 344 (refer to FIG. 3) retrieves 602 the user profile and other information associated with the user activity related to the virtual desktop (hereinafter referred to as the “user activity information”).

Then, the advertisement selection engine 344 analyzes 606 the user profile and the user activity information to select advertisements from the advertisement database 358 that may be of interest or relevance to the users. Information other than the user profile and the user activity information may also be used to select advertisements pertinent to the users. In one embodiment, the user's geographic location is taken into account to select the advertisements pertinent to the users.

The user activity information may include, but is not limited to, user login information, application usage information and the metadata of files. The login information may include, for example, the IP address of the user terminal 130, the starting time of the virtualization session, the ending time of the virtualization session, the operating system 542 of the user terminal 130, and the type and version of the access module 538. The login information may be collected over multiple sessions and may be indicative of a user's pattern of usage.

The application usage information is accumulated in the file storage server 170 each time a user launches an application on a virtual desktop. The application usage information may include, among other information, the identity of the launched application, the time at which the application was launched, the time at which the application was closed, types of operations performed on the application. The application usage information may indicate the user's preference of applications and types of media items often accessed by the user. Hence, the application usage information may be useful in selecting the modes and types (e.g., video clip or static images) of advertisements to be presented to the user.

In one embodiment, the advertisement selection engine 344 consists of a set of rules that prioritizes the advertisements for each user. In the advertisement database 358, each advertisement is associated with statistical information of advertisements and/or demographic information of users. The statistical information is collected and managed by the service server 220 as the users interact with the advertisements. The demographic information indicates demographics of users targeted by the advertisers. The advertisement selection engine 334 may apply, for example, regression analysis to generate a list of advertisements that is likely to attract the attention of the user or is likely to be relevant to the user. The advertisement selection engine 334 may also use geocoding information determined by, for example, the current IP address of the user's session to select relevant advertisements.

Further, the advertisement selection engine 344 may filter the advertisements based on restrictions defined by the advertisers. The restrictions may include, for example, (i) the time (day, month or year) when the advertisements should be presented, (ii) whether the advertisements should be targeted to power users or casual users, (iii) the geographic locations of the users to whom the advertisements should be presented, and (iv) the user's budget.

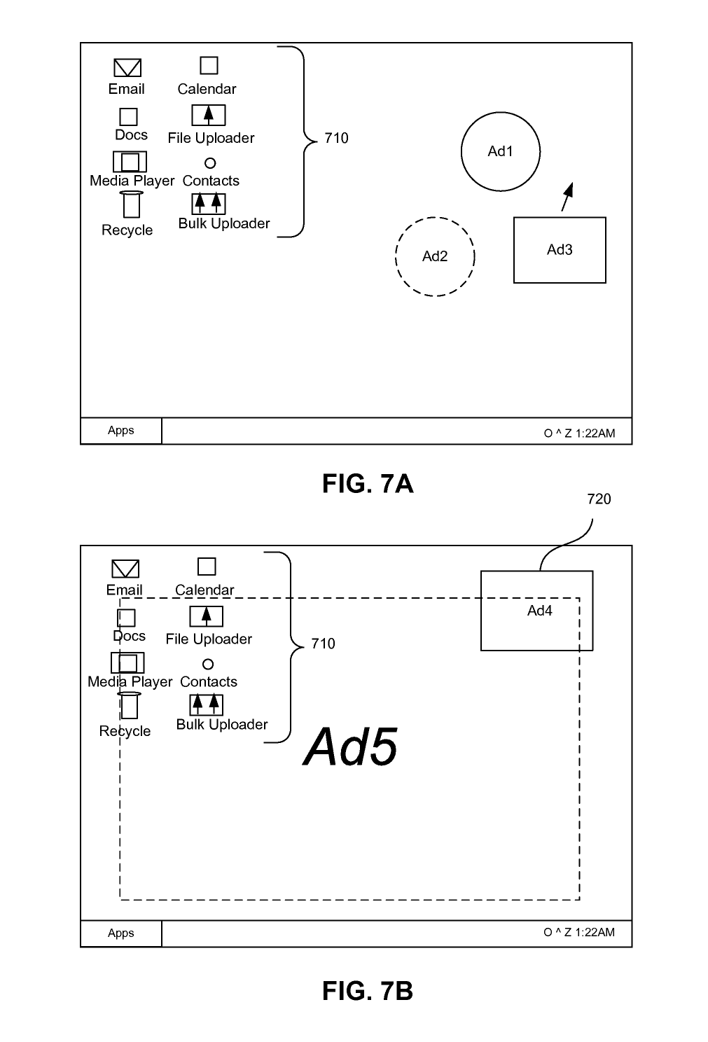

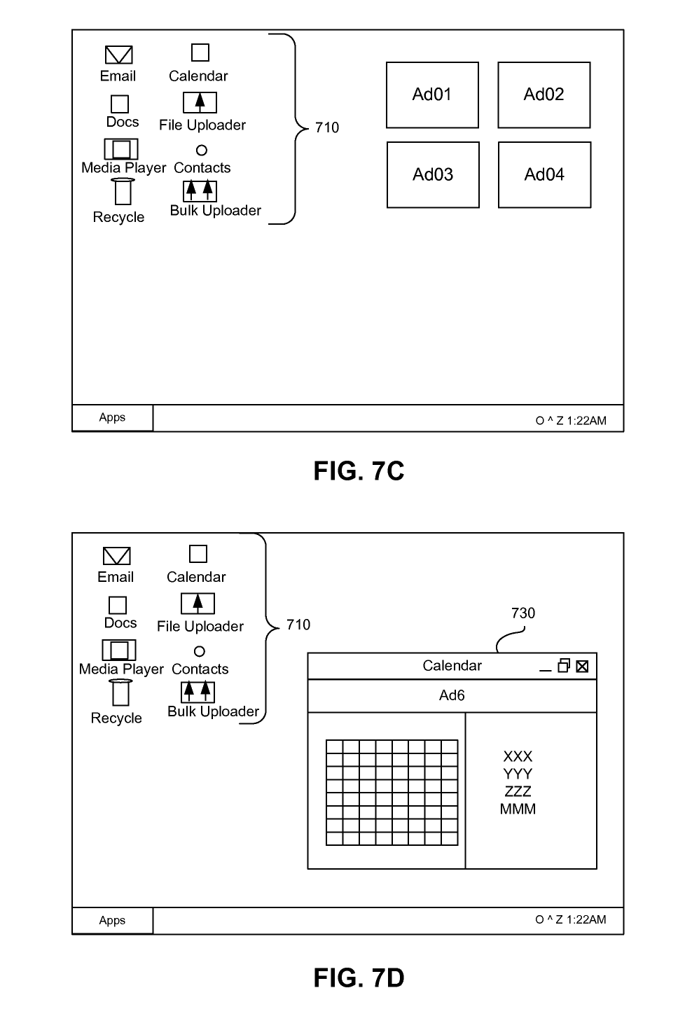

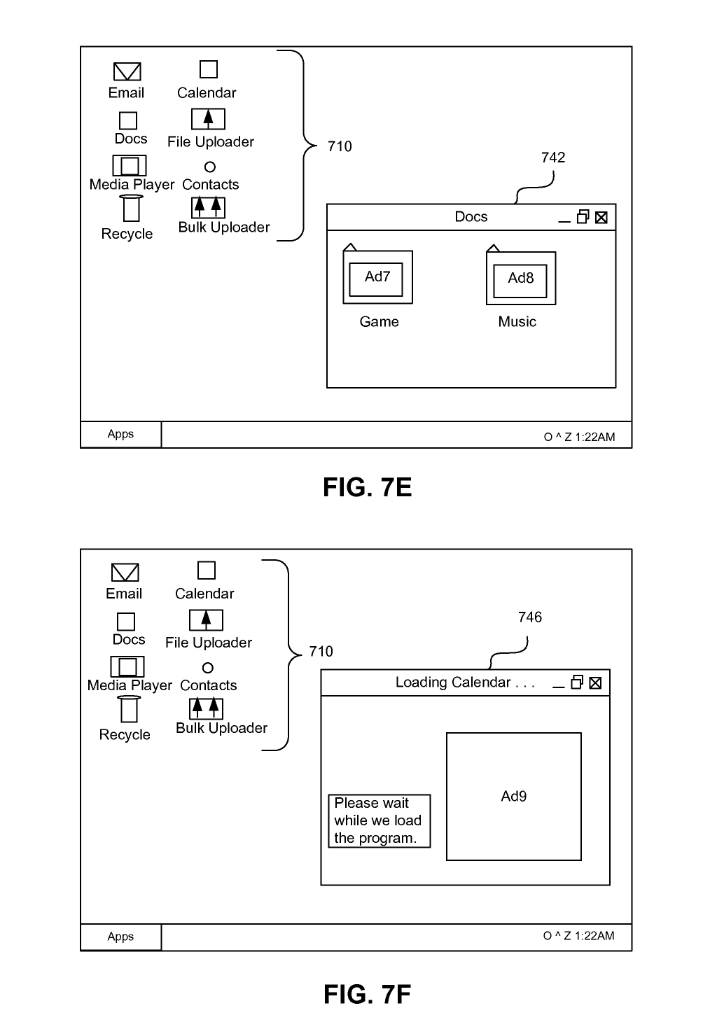

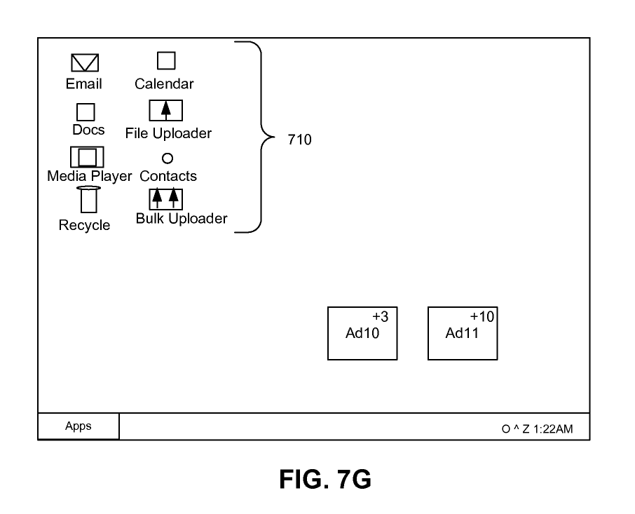

The advertisement selection engine 344 may also determine the mode of presenting the advertisement to the user. The mode may include, for example, the language of the advertisement, the types of advertisements to be presented to the user (e.g., background image or banner advertisement), and whether to receive input from the user indicating preference (e.g., like or dislike) of the advertisement. Example modes of advertisements are described below in detail with reference to FIGS. 7A through 7G.

The advertisement selection engine 344 provides to the advertisement manager 418 (refer to FIG. 4) the prioritized list of advertisements and mode information indicating how the advertisements should be presented on the user terminals 130. In one embodiment, the mode of advertisement is selected in accordance with the predominant types of files that the users access.

When a virtual desktop session starts, the advertisement manager 418 (refer to FIG. 4) receives the selected advertisements and modes of presentation from the advertisement selection engine 344. The advertisement manager 418 fetches advertisements from the advertisement database 358 as indicated by the prioritized list of advertisements. Then, the advertisement manager 418 converts 610 the advertisements into advertisement objects. In one embodiment, the advertisements are encoded and packaged into JSON objects.

The advertisement objects are then included 614 in the data objects for transmittal to the user terminals 130 via the web server 210. In one embodiment, the data objects including the advertisement objects are sent 618 to the user terminals 130 via the web server 210 as a HTTP response. At the user terminals 130, the access module 538 decodes the data objects to extract the advertisement objects as well as other user interface elements (e.g., window objects, menu objects, theme objects and user session objects) for generating a graphical user interface on the user terminal 130, as described above in detail with reference to FIG. 5.

In one embodiment, the advertisement objects are indistinguishable from other data objects related to user interface elements (e.g., window objects, menu objects, and theme objects). That is, the advertisement objects include the same data fields, processed and rendered in the same manner as other data objects. By rendering the advertisement objects indistinguishable from other data objects, the user terminal 130 cannot conveniently distinguish the advertisement objects from other data object by parsing through the data fields of the data objects; and thus, renders filtering out of the advertisement objects at the user terminal 130 more difficult or impractical.

If the user selects an advertisement at the user terminal 130 and takes an action on the selected advertisement (e.g., click the advertisement), the access module 538 sends event information indicating the selected advertisement and the action to the service server 220. The service server 220 receives 622 the event information and then takes 624 actions based on the received event information. The actions taken at the service server 220 may include, for example, (i) sending one or more data objects associated with the selected advertisement, (ii) updating the statistical information in the advertisement database 358 associated with the selected advertisement, and (iii) updating a corresponding advertiser's account for charging the advertisement fees. The data objects associated with the selected advertisement may include media items such as a webpage, an image and a video clip.

In one embodiment, the advertisement manager 418 determines 626 operation parameters associated with the virtual desktop. The operation parameters may include, but are not limited to, the time elapsed since the user logged on, the amount of resources (e.g., memory or processing time) used by the users in association with the virtual desktops, the current geographic location of the user, and the previous time at which the user acted on a displayed advertisement. The virtual desktop service provider may also define other operation parameters relevant to selecting or updating of the advertisements.

The advertisement manager 418 updates 630 advertisements or their modes of presentation based on the actions taken at the user terminal 130 and/or the operation parameters. Specifically, the advertisements displayed on the virtual desktop may be removed, modified or added responsive to receiving user inputs from the user terminal 130 or detecting changes in the operation parameters. For example, if a user clicks on an advertisement and views the advertisements, all or some of the advertisements may be removed from the virtual desktop for a predetermined amount of time before a new advertisement appears in the virtual desktop. Also, if the time elapses without receiving the user inputs representing an action on the advertisements, the advertisements may become more conspicuous (e.g., the size of the advertisement increased, the frequency of blinking increased, and the speed of movement in the advertisement increased) to attract attention from the user. The change in the modes of the advertisement may include, for example, displaying a static advertisement instead of a dynamic advertisement.

After updating the selected advertisements or their modes of presentation, the process of FIG. 6 returns to converting 610 selected advertisements into advertisement objects and the subsequent steps are repeated unless the virtual desktop session is terminated.

The process illustrated in FIG. 6 is merely illustrative. Various changes may be made to the process of FIG. 6. For example, instead of analyzing 606 the user profile and the user activity information, the advertisements and the modes of presentation may be selected randomly.

Also, receiving 622 of the event information related to advertisements may be omitted. Instead, the advertisement objects may include code that allows the user terminal 130 to take actions spontaneously without sending the event information to the service server 220. Further, the sequence of steps in the process may also vary. For example, taking 624 actions by the advertisement manager 418 may follow determining 626 of the operation parameters.

Example Graphical User Interfaces with Advertisements

FIG. 7A is a graphical user interface of a virtual desktop as presented on the user terminal 130, according to one embodiment. The graphical representation includes three advertisements Ad1 through Ad3 and icons 710 for prompting various operations on the virtual desktop. For illustrative purposes, all of the advertisements are presented in different modes of presentation. In practice, however, a graphical representation is likely to be presented using only one or two modes of presentation.

Advertisement Ad1 is in a mode where the advertisement is fixed in shape and location. Advertisement Ad2 is in a mode where the advertisement blinks, changes its shape or size with progress of time to attract attention from the user. The frequency of blinking or the size of the icon may be increased with progress of time to attract attention if the user fails to action upon advertisement Ad2. Advertisement Ad3 is in a mode where the advertisement moves around different locations in the graphical user interface. The movement may be translational, rotational, random or a combination of various movements.

In one embodiment, the advertisement icons remain in the screen of the user terminal 130 until the user clicks on the advertisement icons. After clicking an advertisement, an advertising window displaying the corresponding advertisement may be launched on the screen. The advertisement window may display media items such as a video clip, a webpage or an animation in the foreground part of the screen. After presenting the advertisement window, the user may be prompted to answer questions such as whether the user liked or disliked the advertisement. Subsequently, all advertisement icons previously displayed on the screen (advertisement icons Ad1 through Ad3) may be removed or only the clicked advertisement icon may be removed from the screen. For these types of advertisements, the advertisers are likely to pay advertisement fees on a pay-per-click basis.

Alternatively, the user may be asked whether the user wants to keep the advertisement on the graphical user interface. If the user answers in the affirmative, then the advertisement remains on the screen.

FIG. 7B is a graphical user interface of a virtual desktop as presented on the user terminal 130, according to another embodiment. The graphical representation of FIG. 7B includes advertisement Ad5 that is presented in a mode where the advertisement appears as a background image of the virtual desktop. The background image may change with progress of time. Alternatively, the background image may change based on user activities. For example, if a user launches a music application, the background image may include advertisement for newly released albums. For advertisements presented as background images, the advertisers are likely to pay advertisement fees on a pay-per-impression basis.

The graphical representation of the virtual desktop also includes window 720 that is a virtual billboard. The window 720 displays multiple advertisements in sequence. The user may click the window 720 to launch a video clip, a webpage or an animation associated with the advertisement currently being displayed in the window 720. For the advertisements presented in the virtual billboard, the advertisers are likely to pay advertisement fees on a pay-per-click basis.

FIG. 7C is a graphical user interface of a virtual desktop as presented on the user terminal 130, according to another embodiment. Based on user activities, shortcut icons Ad01 through Ad04 may be displayed on the screen. Each shortcut is associated with an advertiser's website or web application. As time elapses, the number of shortcuts appearing on the screen increases unless the user clicks one of the shortcuts. The user can remove the shortcuts by clicking the shortcuts and launching the website or web application associated with the shortcuts. After viewing the advertisement, the user can provide feedback. The feedback may indicate whether the user liked or disliked the advertisement as well as whether the user would prefer to keep the shortcut on the screen. The feedback from the user can be used for computing advertisement fees (e.g., “liked” advertisements or “keep” the shortcut on the screen charged at a higher fee) and also improving the targeting of advertisements to the users.

Alternatively, the advertisers may purchase advertisement space in the graphical user interface for displaying the advertiser's shortcuts in the virtual desktop. The purchased advertisement space is reserved for the advertiser and remains on the virtual desktop unless the user converts to a paid subscriber of the virtual desktop service.

FIG. 7D is a graphical user representation of a virtual desktop as presented on the user terminal 130, according to another embodiment. After an application is launched, an advertisement (e.g., advertisement Ad6) is displayed on the label of an application window 730. The advertisement displayed on the label may be changed with the progress of time. For advertisements presented on the label, the advertisers are likely to pay advertisement fees on a pay-per-impression basis.

FIG. 7E is a graphical user interface of a virtual desktop as presented on the user terminal 130, according to another embodiment. In this embodiment, the advertisements are overlaid on top of the graphical representations of folders or files. FIG. 7E illustrates a folder 742 including two sub-folders “Game” and “Music.” In one embodiment, the advertisements for overlaying on the folder icons are selected to have relevance to the title or subject of the folder. For example, advertisements of recently released games may appear as Ad7 while advertisements of newly release music albums may appear as Ad8. For advertisements overlaid on the folder icons, the advertisers are likely to pay advertisement fees on a pay-per-impression basis.

FIG. 7F is a graphical user interface of a virtual desktop as presented on the user terminal 130, according to another embodiment. The advertisements may be presented on a window 746 indicating loading of the application. When a user clicks on “Calendar” icon, for example, advertisement Ad9 may be displayed in the window 746 while the application is being loaded. An intentional delay in loading of the application may be introduced to increase the time the advertisement Ad9 is presented to the user. In one embodiment, the advertisement presented in the launching window 746 advertises products or services related to or relevant to the application being launched.

FIG. 7G is a graphical user interface of a virtual desktop as presented on the user terminal 130, according to another embodiment. The advertisements may be accompanied by a number or other indications representing the number of items associated with the service or products being advertised. For example, “+3” and “+10” appearing at the right top corners of advertisements Ad10 and Ad11 indicate the number of items remaining for sale. The service server 220 may also take into account the region where the user is located to determine the numbers to appear at the right top corner of the advertisements Ad10 and Ad11. For example, the number “+3” and “+10” may represent the real-time number of items available for sale remaining at a local seller in the region where the user resides.

### Additional Modes of Advertisements

In addition to the modes of presenting advertisements as described in detail with reference to FIGS. 7A through 7G, other modes of presenting advertisement may also be employed. In one embodiment, the advertisements may be presented in a screen saver in place of default or generic screen saver when a user takes no action on the virtual desktop for a predetermined amount of time. The advertisements presented in the screen saver may change with progress of time or upon detecting an event.

In one embodiment, the advertisements are presented in a modal or non-modal dialog box. The dialog boxes include messages from the advertisers in various areas of the virtual desktop representation. The modal dialog box renders user inputs not associated with the advertisements invalid. The user can resume further operations on the virtual desktop after the user responds to the modal dialog box by clicking the modal dialog box or typing in answers in the modal dialog box. Non-modal dialog boxes, on the other hand, allows the users to perform operations on the virtual desktop without taking actions on the dialog box. The non-modal dialog boxes remain on the screen until the user takes actions on the dialog boxes.

In one embodiment, the advertisements are presented in a login screen for accessing the virtual desktop. Since the user is unknown before the user logs in, the advertisements presented in the login screen cannot be customized based on the user information. However, the service server 220 may consider the time of log-in or geographic location of the user (based on the IP address of the user terminal 130) to select the advertisements for presentation on the login screen.

### Alternative Embodiments

In one embodiment, incentives may be provided by advertisers for using the virtual desktop. The advertisers may offer coupons or discounts to the users who used the virtual desktop for a predetermined length of time or the users who viewed the advertisements of the advertisers for a certain number of times. For example, if a user consistently selected one advertisement over other advertisements, the advertiser of the chosen advertisement may offer a coupon or discount to the user.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A method of virtualizing a plurality of computers at a computing device, comprising:
selecting one or more advertisements from a plurality of advertisements;
converting the one or more selected advertisements into one or more advertisement objects configured for transmittal over a network;
including the one or more advertisement objects in first data objects for generating user interface elements at a user terminal; and
sending the first data objects over the network to a user terminal to generate a graphical user interface for accessing a computer virtualized at the computing device, the graphical user interface displaying the user interface elements and the one or more selected advertisements.

2. The method of claim 1, further comprising:
receiving event information representing selection of an advertisement at the user terminal;
generating a second data object including a media item associated with the advertisement selected at the user terminal; and
sending the second data object to the user terminal over the network.

3. The method of claim 2, wherein the second data object comprises at least one of an image, a video clip, a webpage or an animation.

4. The method of claim 2, further comprising updating statistical information associated with the advertisement selected at the user terminal.

5. The method of claim 1, wherein converting the one or more selected advertisements comprises encoding and packaging the one or more selected advertisements into one or more JSON objects (JavaScript Object Notation).

6. The method of claim 1, wherein the one or more advertisements are selected at the computing device based on a user profile or information related to user activity associated with the virtualized computer.

7. The method of claim 6, wherein the user profile comprises at least one of user's contact information, the user's demographic information, the user's preferred language, the user's geographic location, and the user's field of interest.

8. The method of claim 1, wherein the computing device sends the first data objects to the user terminal using HTTP (Hypertext Transfer Protocol) or its variant protocol.

9. The method of claim 1, further comprising selecting a mode of presenting the one or more advertisements on the user terminal.

10. The method of claim 9, wherein the mode of presentation comprises at least one of:
a first mode where at least one advertisement is displayed at a stationary location in the graphical user interface;
a second mode where at least one advertisement blinks, changes shape, changes size or location in the graphical user interface;
a third mode where at least one advertisement appears as a background image;
a fourth mode where at least one advertisement appears in a login screen for accessing the virtualized computer;
a fifth mode where at least one advertisement appears in a screen saver;
a sixth mode where at least one advertisement appears in a label of an application window;
a seventh mode where at least one advertisement is overlaid on a graphical user interface element representing a file or folder;
an eighth mode where at least one advertisement appears in a graphical user element indicating loading of an application; and
a ninth mode where at least one advertisement appears in a dialog box.

11. The method of claim 1, further comprising displaying numbers of items associated with the one or more selected advertisements remaining at a business establishment in proximity to the user terminal.

12. The method of claim 1, comprising storing a computer profile for each virtual computer, the computer profile comprising at least one of (i) information associated with the graphical user elements, (ii) user preferences associated with the virtual computer, (iii) information about association of file types with application programs, (iv) language associated with a user of the user terminal, (v) application permissions for controlling availability of application to the user terminal and (vi) user's geographic location.

13. A computer system for virtualizing a plurality of computers, comprising:
an advertisement database storing a plurality of advertisements;
an advertisement selection engine configured to select one or more advertisements from the advertisement database;
an advertisement manager configured to:
receive the selected one or more advertisements; and
convert the one or more received advertisements into one or more advertisement objects configured for transmittal over a network;
including the one or more advertisement objects in first data objects for generating user interface elements at a user terminal; and
a communication module configured to send the first data objects over the network to a user terminal to generate a graphical user interface for accessing a computer virtualized at the computing device, the graphical user interface displaying the user interface elements and the one or more selected advertisements.

14. The computer system of claim 13, wherein the advertisement manager is further configured to:
receive event information representing selection of an advertisement at the user terminal; and
generate a second data object including a media item associated with the advertisement selected at the user terminal, the second data sent to the user terminal over the network.

15. The computer system of 14, wherein the advertisement manager is further configured to update statistical information associated with the advertisement selected at the user terminal.

16. The computer system of claim 13, wherein the advertisement selection engine is configured to select the one or more advertisements based on a user profile or information related to user activity associated with the virtualized computer, wherein the user profile comprises at least one of user's contact information, the user's demographic information, the user's preferred language, the user's geographic location and the user's field of interest.

17. The computer system of claim 13, wherein the advertisement manager is configured to encode and package the one or more selected advertisements into one or more JSON objects (JavaScript Object Notation).

18. The computer system of claim 13, wherein the communication module is configured to send the first data objects to the user terminal using HTTP (Hypertext Transfer Protocol) or its variant protocol.

19. The computer system of claim 13, wherein modes of presenting the one or more selected advertisements at the user terminal comprises at least one of:
a first mode where at least one advertisement is displayed at a stationary location in the graphical user interface;
a second mode where at least one advertisement blinks, changes shape, changes size or location in the graphical user interface;
a third mode where at least one advertisement appears as a background image;
a fourth mode where at least one advertisement appears in a login screen for accessing the virtualized computer;
a fifth mode where at least one advertisement appears in a screen saver;
a sixth mode where at least one advertisement appears in a label of an application window;
a seventh mode where at least one advertisement is overlaid on a graphical user interface element representing a file or folder;
an eighth mode where at least one advertisement appears in a graphical user element indicating loading of an application; and
a ninth mode where at least one advertisement appears in a dialog box.

20. A computer-readable storage medium storing instructions thereon, the instructions when executed by a processor in a computing device for virtualizing a plurality of computers, cause the processor to:
select one or more advertisements from a plurality of advertisements;
convert the one or more selected advertisements into one or more advertisement objects configured for transmittal over a network;
include the one or more advertisement objects in first data objects for generating user interface elements at a user terminal; and
send the first data objects over the network to a user terminal to generate a graphical user interface for accessing a computer virtualized at the computing device, the graphical user interface displaying the user interface element and the one or more selected advertisements.
